(19) United States
(12) Patent Application Publication
(10) Pub. No.: US 2026/0104369 A1
(43) Pub. Date: Apr. 16, 2026

(54) APPARATUS AND METHOD FOR DETECTING REFLECTIVE ELECTRON

(71) Applicant: SAMSUNG ELETRONICS CO., LTD., Suwon-si (KR)

(72) Inventor: Ryuju SATO, Yokohama Shi (JP)

(73) Assignee: SAMSUNG ELETRONICS CO., LTD., Suwon-si (KR)

(21) Appl. No.: 19/237,527

(22) Filed: Jun. 13, 2025

(30) Foreign Application Priority Data
Oct. 10, 2024 (JP) 2024-177837
Nov. 25, 2024 (KR) 10-2024-0169872

(51) Int. Cl. G01N 23/207

(52) U.S. Cl. CPC G01N 23/2076; G01N 2223/052; G01N 2223/304

(57) ABSTRACT

Provided is a reflective electron detection apparatus and a reflective electron detection method for acquiring an energy loss spectrum with higher precision. A reflective electron detection apparatus includes an irradiator configured to irradiate a target surface of a sample with an electron, a detector configured to detect at least a portion of the electron which is reflected from the target surface, a voltage application circuitry configured to apply a voltage to the sample, and a correction circuitry configured to correct a first electric field between the target surface of the sample to which is the voltage is applied and the irradiator and a second electric field between the target surface of the sample to which is the voltage is applied and the detector.

### CROSS-REFERENCE TO RELATED APPLICATIONS

This application is based on and claims priority from Japanese Patent Application No. 2024-177837, filed on Oct. 10, 2024, in the Japanese Patent Office, and Korean Patent Application No. 10-2024-0169872, filed on Nov. 25, 2024, in the Korean Intellectual Property Office, the disclosures of which are incorporated herein by reference in their entireties.

### BACKGROUND

### 1. Field

One or more example embodiments of the present disclosure relate to a reflective electron detection apparatus and a reflective electron detection method.

### 2. Description of Related Art

A method of acquiring information on a state of a sample surface includes reflection electron energy loss spectroscopy (REELS). In the REELS, a sample is irradiated with an electron ray in a vacuum container, and energy of an electron reflected from a sample surface is measured. Specifically, with what probability and to what degree an electron projected on the sample surface loses energy are analyzed, and an energy loss spectrum is generated. From the energy loss spectrum, an inelastic scattering process of the electron ray in a sample may be examined, and a chemical state of the sample surface may be evaluated.

### SUMMARY

One or more example embodiments of the present disclosure address the problem in the related art that generating an energy loss spectrum with high precision is difficult in reflection electron energy loss spectroscopy (REELS), and provide a reflective electron detection apparatus and a reflective electron detection method for acquiring an energy loss spectrum with higher precision.

According to an aspect of an example embodiment, there is provided a reflective electron detection apparatus including an irradiator configured to irradiate a target surface of a sample with at least one electron, a detector configured to detect at least a portion of the at least one electron which is reflected from the target surface, a voltage application circuitry configured to apply a voltage to the sample, and a correction circuitry configured to correct a first electric field between the target surface of the sample to which is the voltage is applied and the irradiator and a second electric field between the target surface of the sample to which is the voltage is applied and the detector.

The correction circuitry may include a first planar electrode between the irradiator and the target surface, and a second planar electrode between the detector and the target surface.

The first planar electrode may be configured to correct the first electric field such that the at least one electron which passes through the first electric field proceeds toward the target surface, and the second planar electrode may be configured to correct the second electric field such that the at least a portion of the at least one electron which passes through the second electric field proceeds toward the detector.

The at least one electron which is projected from the irradiator may reach the target surface through a first passage provided to the first planar electrode, and the at least a portion of the at least one electron which is reflected from the target surface may reach the detector through a second passage provided to the second planar electrode.

A surface of the first planar electrode may face the irradiator, and a surface of the second planar electrode may face the detector.

The first passage may include an opening provided to the first planar electrode, and the second passage may include an opening provided to the second planar electrode.

The first passage may include a slit provided to the first planar electrode, and the second passage may include a slit provided to the second planar electrode.

The first planar electrode and the second planar electrode may be connected to each other.

The first planar electrode and the second planar electrode may be separated from each other.

The correction circuitry may be configured to generate a first magnetic field between the irradiator and the target surface and a second magnetic field between the detector and the target surface.

The correction circuitry may be configured to offset, by using the first magnetic field, a component of a force, of the at least one electron which passes through the first electric field, applied in a direction substantially perpendicular to an optical axis of the irradiator, and the correction circuitry may be configured to offset, by using the second magnetic field, a component of a force, of the at least a portion of the at least one electron which passes through the second electric field, applied in a direction substantially perpendicular to an optical axis of the detector.

The irradiator and the detector may be in different directions from the target surface.

The detector may be configured to analyze an energy of the at least part of the at least one electron which is detected.

According to an aspect of an example embodiment, there is also provided a reflective electron detection apparatus including one or more circuitries configured to: correct a first electric field between a target surface of a sample to which a voltage is applied and an irradiator configured to irradiate the target surface with at least one electron, and correct a second electric field between the target surface of the sample to which the voltage is applied and a detector configured to detect at least a portion of the at least one electron which is reflected from the target surface.

The one or more circuitries may include a first planar electrode between the irradiator and the target surface and to which the voltage is applied, and a second planar electrode between the detector and the target surface and to which the voltage is applied.

The first planar electrode may be configured to correct the first electric field such that the at least one electron which passes through the first electric field proceeds toward the target surface, and the second planar electrode may be configured to correct the second electric field such that the at least a portion of the at least one electron which passes through the second electric field proceeds toward the detector.

The one or more circuitries may include a correction circuitry configured to generate a first magnetic field between the irradiator and the target surface and a second magnetic field between the detector and the target surface.

The correction circuitry may be configured to offset, by using the first magnetic field, a component of a force, of the at least one electron which passes through the first electric field, applied in a direction substantially perpendicular to an optical axis of the irradiator, and the correction circuitry may be configured to offset, by using the second magnetic field, a component of a force, of the at least a portion of the at least one electron which passes through the second electric field, applied in a direction substantially perpendicular to an optical axis of the detector.

The irradiator and the detector may be in different directions from the target surface.

According to an aspect of an example embodiment, there is also provided a reflective electron detection apparatus including a memory in which at least one instruction is stored, and at least one processor configured to, by executing the at least one instruction: control to correct a first electric field between a target surface of a sample, to which a voltage is applied, and an irradiator, such that the target surface is irradiated with at least one electron passing through the corrected first electric field from the irradiator; control to correct a second electric field between the target surface of the sample to which the voltage is applied and a detector; and detect, by using the detector, at least a portion of the at least one electron reflected from the target surface and passing through the corrected second electric field.

### BRIEF DESCRIPTION OF FIGURES

These and/or other aspects, features, and advantages of the disclosure will become apparent and more readily appreciated from the following description of example embodiments, taken in conjunction with the accompanying drawings of which:

FIG. 1 is a schematic diagram illustrating an example of a configuration of a reflective electron detection apparatus according to one or more example embodiments of the present disclosure;

FIG. 2 is a perspective diagram illustrating an example of a configuration of a correction unit illustrated in FIG. 1;

FIG. 3 is a perspective diagram illustrating another example of a configuration of a correction unit illustrated in FIG. 1;

FIG. 4 is a flow chart illustrating an example of a method in which an electron is detected by a reflective electron detection apparatus illustrated in FIG. 1;

FIG. 5 is a diagram illustrating an example of a distribution of energy of an electron emitted from a sample;

FIG. 6 is a schematic diagram illustrating examples of a first electric field and a second electric field corrected by a correction unit of FIG. 1;

FIG. 7 is a schematic diagram illustrating examples of a first electric field and a second electric field formed in a reflective electron detection apparatus according to a comparative example;

FIG. 8 is a schematic diagram illustrating an example of a configuration of a reflective electron detection apparatus according to one or more example embodiments;

FIG. 9A is a diagram illustrating a cross-sectional configuration taken along line A-A illustrated in FIG. 8;

FIG. 9B is a diagram illustrating a cross-sectional configuration taken along line B-B illustrated in FIG. 8; and

FIG. 10 is a flow chart illustrating an example of a method in which an electron is detected by a reflective electron detection apparatus illustrated in FIG. 8.

### DETAILED DESCRIPTION

Hereinafter, example embodiments of the present disclosure will be described with reference to the accompanying drawings. In the following drawings, the same reference numerals may represent the same elements, and a size of each element on the drawings may be shown in a ratio different from an actual size for clarity and convenience for description. The one or more embodiments described below are merely provided as an example(s) and may be variously modified.

Hereinafter, a position described as being above or on an element may include a position thereon without being in contact therewith as well as a position in contact therewith to be directly thereon.

An element expressed with a term in a singular form includes a plurality of elements unless an apparently and contextually conflicting description is present. Also, that a portion “includes” or “has” an element means that another element is not excluded and may be further included unless particularly described otherwise.

In addition, use of the term “the” or similar terms is applied to any one of a singular term and a plural term.

With respect to operations forming a method, the operations are executed in appropriate order unless an order thereof is specifically described as being required or a conflicting description is present. An order of descriptions of the operations is merely an example, and unless the order of operations is clearly stated or stated to the contrary, these operations may be performed in any appropriate order and are not necessarily limited to the order described. Use of all examples or example terms (e.g., “for example” or the like) is simply to describe the technical spirit in detail. Accordingly, the scope of the present disclosure is not limited by the examples or the example terms unless limited by the claims.

### (Configuration of Reflective Electron Detection Apparatus 1)

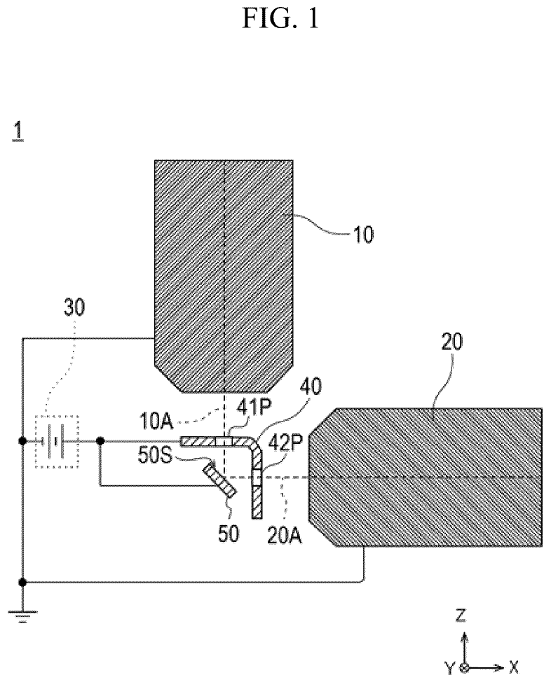

FIG. 1 illustrates an example of a schematic configuration of a reflective electron detection apparatus 1 according to one or more example embodiments of the present disclosure. The reflective electron detection apparatus 1 may include, for example, an irradiator 10, a detector 20, a voltage application part (or voltage application circuitry) 30, and a correction unit (or correction circuitry) 40. The reflective electron detection apparatus 1 may analyze a target surface 50S of a sample 50 by using, for example, reflection electron energy loss spectroscopy (REELS). Specifically, the target surface 50S may be irradiated with an electron from the irradiator 10, and the electron may be reflected from the target surface 50S. The detector 20 may detect the electron reflected from the target surface 50S and analyze energy of the detected electron. Accordingly, an energy loss spectrum of the sample 50 may be acquired. The irradiator 10 and the detector 20 may be grounded.

The irradiator 10 may project the electron along an optical axis 10A. The irradiator 10 may include, for example, an electron source, an electron acceleration device, an electron deflector, and/or an electron lens. The electron source may emit, for example, an electron having predetermined energy. In the electron acceleration device, a predetermined amount of kinetic energy is granted to the electron emitted from the electron source. The electron deflector and the electron lens may adjust a direction of the electron granted the kinetic energy and concentrate electrons toward the sample 50. Energy of the electron projected from the irradiator 10 ranges, for example, from 0.1 to 30 kiloelectronvolts (keV).

In the detector 20, the electron which is incident along an optical axis 20A may be detected. The detector 20 may include, for example an energy analyzer using a bias-variation scheme. The energy analyzer may be, for example, an energy analyzer using a magnetic field deflection scheme, an electrostatic deflection scheme, a Wien-filter scheme, and/or the like. The detector 20 may have a shape of, for example, a hemisphere, a circular sector, a coaxial cylinder, or the like. The detector 20 may detect the electron by using, for example, a channeltron, a multichannel plate, or the like. The detector 20 may detect the electron by using a scintillator and a photomultiplier tube. The detector 20 may include an amplifier.

The sample 50 may be disposed at an intersection point of the optical axis 10A of the irradiator 10 and the optical axis 20A of the detector 20. The optical axis 10A and the optical axis 20A may cross at an angle ranging, for example, from sixty to one hundred and twenty degrees. An angle formed by the target surface 50S of the sample 50 and the optical axis 10A of the irradiator 10 may be, for example, greater than or equal to zero degree and less than or equal to ninety degrees. An angle formed by the target surface 50S of the sample 50 and the optical axis 20A of the detector 20 may be, for example, greater than or equal to zero degree and less than or equal to ninety degrees. The sample 50 may be disposed on, for example, a stage (not illustrated). The stage may move the target surface 50S of the sample 50 relative to the optical axis 10A and the optical axis 20A. The stage may change an angle of the target surface 50S with respect to each of the optical axis 10A and the optical axis 20A. An angle of incidence of the electron on the target surface 50S and an angle of projection of the electron from the target surface 50S may be changed by changing the angel of the target surface 50S with respect to each of the optical axis 10A and the optical axis 20A. Thus, information on a state of the sample 50 may be acquired in various ways. Hereinafter, a direction parallel to the optical axis 10A may be referred to as a Z direction, a direction parallel to the optical axis 20A may be referred to as an X direction, and a direction perpendicular to each of the optical axis 10A and the optical axis 20A may be referred to as a Y direction.

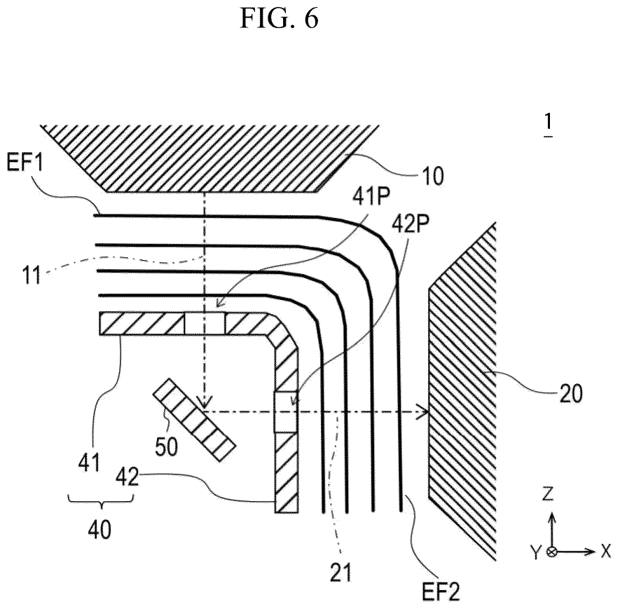

The voltage application part 30 may apply a predetermined positive voltage to each of the correction unit 40 and the sample 50. The voltage application part 30 may apply, for example, a positive voltage ranging from +1 kilovolts (kV) to +5 kV to each of the correction unit 40 and the sample 50. The voltage application part 30 may include, for example, a power source. The positive voltage may be applied to the sample 50, and an electric potential difference may occur between the sample 50 and each of the irradiator 10 and the detector 20. Due to the electric potential difference, a first electric field (e.g., a first electric field EF1 of FIG. 6 described below) between the target surface 50S and the irradiator 10 and a second electric field (e.g., a second electric field EF2 of FIG. 6 described below) between the target surface 50S and the detector 20 may occur. The first electric field may accelerate the electron which passes through the first electric field from the irradiator 10 and proceed toward the target surface 50S. The second electric field may decelerate the electron which passes through the second electric field from the target surface 50S and proceed toward the detector 20. Thus, when compared to a case in which the positive voltage is not applied to the sample 50, energy of the electron with which the target surface 50S is irradiated may be increased, and energy of the electron which moves into the detector 20 may be decreased. Accordingly, precision of an energy loss spectrum acquired in the reflective electron detection apparatus 1 may be improved, which will be described below in detail.

The voltage application part 30 may apply, for example, equal positive voltages to the correction unit 40 and the sample 50. Thus, the correction unit 40 and the sample have an equal electric potential, such that a large electric field does not occur between the correction unit 40 and the sample 50. Magnitudes of the positive voltages applied to the correction unit 40 and the sample 50 are only required to be substantially equal and, for example, may be different by approximately 1%.

The correction unit 40 may serve to correct the first electric field and the second electric field. The correction unit 40 may include, for example, a first planar electrode 41 and a second planar electrode 42. The first planar electrode 41 may be provided between the irradiator 10 and the target surface 50S. The second planar electrode 42 may be provided between the detector 20 and the target surface 50S.

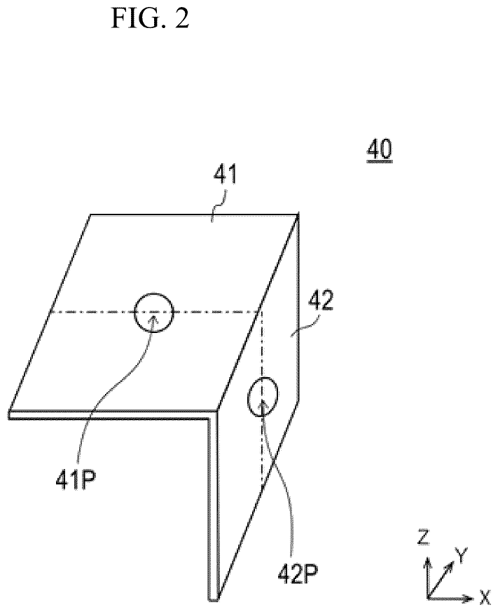

FIG. 2 is a perspective diagram illustrating an example of a configuration of the correction unit 40. One surface (e.g., main surface) of each of the first planar electrode 41 and the second planar electrode 42 may have, for example, a quadrangular shape. The main surface of the first planar electrode 41 may face the irradiator 10. The first planar electrode 41 may have, for example, the main surface which is parallel to an XY plane. In other words, the main surface of the first planar electrode 41 may be disposed in a direction perpendicular to the optical axis 10A of the irradiator 10. Based on this configuration, a first electric field between the target surface 50S and the irradiator 10 may be corrected such that an electron projected from the irradiator 10 proceeds toward the target surface 50S along the optical axis 10A, which will be described below in detail. A position and a direction of the first planar electrode 41 may be fixed relative to the irradiator 10.

A first passage 41P, for example, may be provided to the first planar electrode 41. The first passage 41P may be formed by, for example, an opening that penetrates the first planar electrode 41 in a Z-axis direction. The electron projected from the irradiator 10 may reach the target surface 50S by passing through the first passage 41P. The first passage 41P may be provided at a position corresponding to the optical axis 10A. The first passage 41P may be provided at a central portion of the main surface of the first planar electrode 41 and have a shape of a circular plane.

The second planar electrode 42 may be connected to, for example, the first planar electrode 41. For example, the first planar electrode 41 and the second planar electrode 42 may be integrated. The first planar electrode 41 and the second planar electrode 42 may be electrically connected. The main surface of the second planar electrode 42 may face the detector 20. The second planar electrode 42 may have, for example, the main surface which is parallel to a YZ plane. In other words, the main surface of the second planar electrode 42 may be disposed in a direction perpendicular to the optical axis 20A of the detector 20. Based on this configuration, a second electric field between the target surface 50S and the detector 20 may be corrected such that an electron reflected from the target surface 50S proceeds toward the detector 20 along the optical axis 20A, which will be described below in detail. A position and a direction of the second planar electrode 42 may be fixed relative to the detector 20.

A second passage 42P, for example, may be provided to the second planar electrode 42. The second passage 42P may be formed by, for example, an opening that penetrates the second planar electrode 42 in an X-axis direction. The electron reflected from the target surface 50S may be incident on the detector 20 by passing through the second passage 42P. The second passage 42P may be provided at a position corresponding to the optical axis 20A. For example, the second passage 42P may be provided at a central portion of the main surface of the second planar electrode 42 and have a shape of a circular plane.

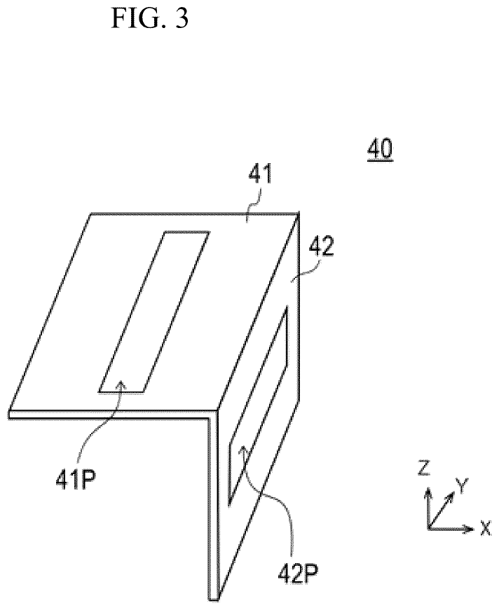

FIG. 3 is a perspective diagram illustrating another example of a configuration of the first passage 41P and the second passage 42P. The first passage 41P and the second passage 42P may have, for example, a shape of a slit. For example, each of the first passage 41P and the second passage 42P may be formed by a slit parallel to a Y-axis. Shapes of the first passage 41P and the second passage 42P may be different from each other. Flexibility of alignment of optical axes 10A and 20A may be improved by providing the first passage 41P and the second passage 42P in a shape of such a slit.

The sample 50 may have, for example, a shape of a circular thin film. A thickness of the sample 50 may range, for example, from 0.2 millimeters (mm) to 1.0 mm. Although not particularly limited, the sample 50 may include, for example, a semiconductor wafer or the like. The sample 50 may include a metallic material or an insulation material formed as a film on a semiconductor wafer.

### (Method of Detecting Electron Using The Reflective Electron Detection Apparatus 1)

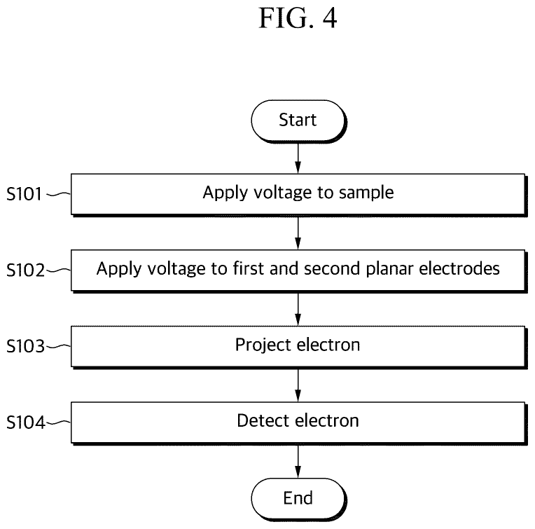

FIG. 4 is a flow chart illustrating an example of a method of detecting an electron using the reflective electron detection apparatus 1. In operation S101, initially, the reflective electron detection apparatus 1 may apply a positive voltage of a predetermined magnitude to the sample 50. In operation S102, the reflective electron detection apparatus 1 may apply the positive voltage of the predetermined magnitude to the first planar electrode 41 and the second planar electrode 42. Accordingly, a first electric field between the target surface 50S and the irradiator 10 and a second electric field between the target surface 50S and the detector 20 may be corrected.

For example, the voltage application part 30 may apply the positive voltage to the sample 50, the first planar electrode 41, and the second planar electrode 42. An order of operations S101 and S102 may be reversed, or operations S101 and S102 may be simultaneously processed.

In operation S103, after the positive voltage is applied to the first planar electrode 41 and the second planar electrode 42, the reflective electron detection apparatus 1 may irradiate the target surface 50S of the sample 50 with an electron from the irradiator 10. Since passing through the corrected first electric field, the electron which is projected from the irradiator 10 may proceed along the optical axis 10A and may reach the target surface 50S.

At least one of electrons that reach the target surface 50S may be reflected from the target surface 50S or a vicinity of the target surface 50S. In operation S104, since passing through the corrected second electric field, the reflected electron may proceed along the optical axis 20A and may be detected by the detector 20. In the detector 20, energy analysis of the detected electron may be performed.

### (Effect of The Reflective Electron Detection Apparatus 1)

In the reflective electron detection apparatus 1 of the present disclosure, since a voltage is applied to the sample 50, the first electric field and the second electric field may be formed near the sample 50. The first electric field may accelerate the electron which proceeds from the irradiator 10 to the target surface 50S. The second electric field may decelerate the electron which proceeds from the target surface 50S to the detector 20. Accordingly, while the target surface 50S is irradiated with a high-energy electron, energy of the electron which moves into the detector 20 may be decreased. In addition, the first electric field and the second electric field near the sample 50 may be corrected by the correction unit 40. Thus, trajectories of electrons passing through the first electric field and the second electric field may be appropriately maintained. Thus, an energy loss spectrum may be acquired with higher precision. Hereinafter, the above-described effect will be described in more details.

In transmission-type electron energy loss spectroscopy (EELS), an electron transmitting through a sample is detected and thus the sample is required to be sectioned (or thin-sliced). Also, in order to support the sectioned sample, a support film having a uniform thickness is required. Compared to such the transmission-type EELS, in REELS, a reflected electron is detected in a sample and thus, the sample is not required to be sectioned. In addition, the support film having the uniform thickness is not required. Thus, in the REELS, a state of a sample surface may be further easily analyzed in comparison with the transmission-type EELS.

An apparatus for Auger electron spectroscopy (AES) measurement, for example, may be used for REELS measurement. In the AES, a sample surface is irradiated with an electron, and an Auger electron emitted from the sample surface is analyzed.

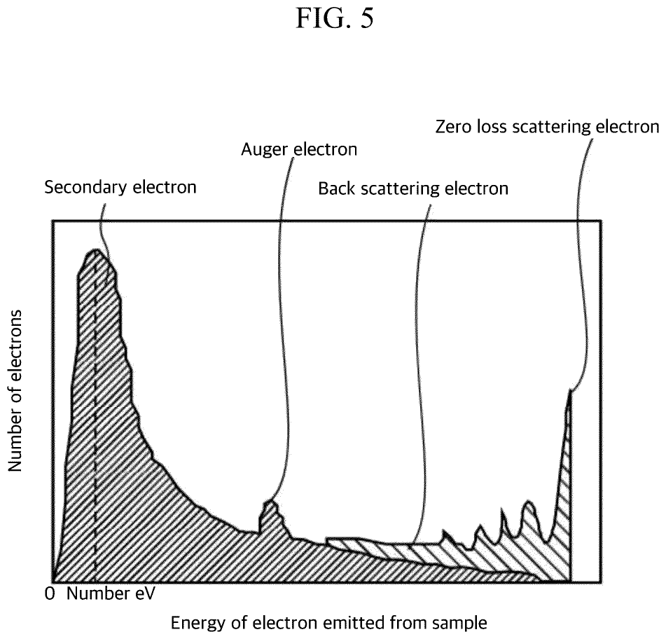

FIG. 5 illustrates an example of a distribution of energy of an electron emitted from a sample. A vertical axis represents a number of emitted electrons, and a horizontal axis represents energy of the electron emitted from the sample. An upward direction of the vertical axis indicates that the number of the emitted electrons is increased, and a rightward direction of the horizontal axis indicates that the energy of the emitted electron is increased. In the AES measurement, the sample is irradiated with an electron having energy greater than or equal to 10 keV, and an Auger electron having energy less than or equal to approximately 2 keV is detected. On the other hand, in the REELS, a back scattering electron including an electron having energy equal to that of a projected electron, namely, a zero loss scattering electron may be detected. In the REELS measurement, as energy of the projected electron is higher, a signal-to-noise (SN) ratio may be improved because mixing with a secondary electron that becomes noise is reduced. This is due to the two following reasons. First, as the energy of the projected electron is higher, an amount of occurrence of secondary electrons may be reduced. Second, as the energy of the projected electron is higher, energy of the zero loss scattering electron may be higher, and thus, a difference between an energy area of an electron used for the REELS measurement and a peak energy area of the secondary electron may be larger.

Also, in the AES, the REELS, and the like, an over-voltage ratio shown in the following Equation 1 is important.

$$U = E 0 / Eb \qquad [ Equation 1 ]$$

In Equation 1, U denotes the over-voltage ratio. E0 denotes the energy of the projected electron. Eb denotes binding energy of a material excited by the electron.

Theoretically, in a case of U>1, the material may be excited by the projected electron. In an embodiment, a spectrum may be measured in a case of U=2 to 20. In addition, a high SN ratio may be acquired generally in a case where U is approximately 10. Even in terms of the over-voltage ratio, as the energy of the projected electron is higher, measurement with high precision may be achieved.

However, in the AES measurement, an electron in an energy area that is high to that extent in the REELS measurement is not required to be detected. Thus, when an apparatus for the AES measurement is applied to the REELS measurement, since an energy value of an electron detectable by a detector is limited, the sample is not irradiated with a high-energy electron, and improving precision of an acquired energy loss spectrum is difficult.

To solve this problem, in the reflective electron detection apparatus 1, a positive voltage may be applied to the sample 50 such that a first electric field (e.g., the first electric field EF1 of FIG. 6 described below) between the target surface 50S and the irradiator 10 and a second electric field (e.g., the second electric field EF2 of FIG. 6 described below) between the target surface 50S and the detector 20 are formed.

FIG. 6 illustrates an equipotential line of the first electric field EF1 and the second electric field EF2. Here, the first planar electrode 41 may be provided between the irradiator 10 and the target surface 50S, and the second planar electrode 42 may be provided between the detector 20 and the target surface 50S. A direction of the first electric field EF1 may be corrected by a direction parallel to an optical axis 11 of the irradiator 10, and a direction of the second electric field EF2 may be corrected in a direction parallel to an optical axis 21 of the detector 20. Hereinafter, a description thereof will be described in more details.

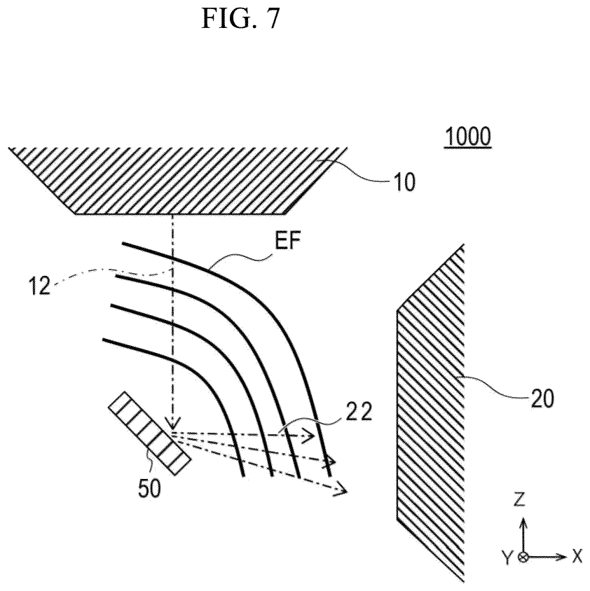

FIG. 7 illustrates an examples of a reflective electron detection apparatus 1000 according to a comparative example. The reflective electron detection apparatus 1000 does not include a correction unit (e.g., the correction unit 40 of FIG. 6) according to one or more embodiments of the present disclosure, which is main difference between the reflective electron detection apparatus 1000 of FIG. 7 and the reflective electron detection apparatus 1 of FIG. 1. When a positive voltage is applied to the sample 50, an electric field EF along the target surface 50S is formed in the reflective electron detection apparatus 1000. Since the irradiator 10 and the detector 20 are disposed in directions in which respective optical axes 12 and 22 of the irradiator 10 and the detector 20 cross each other, the electric field EF formed near the target surface 50S is misaligned with a direction parallel to at least one of the optical axis 12 and the optical axis 22. Since an electron passing through the electric field EF is affected by a deflection effect, a trajectory of the electron is distorted. In other words, the trajectory of the electron deviates from at least one of optical axes 12 and 22 of the irradiator 10 and the detector 20.

For example, due to a deflection function of the irradiator 10, an electron reflected from the target surface 50S may be allowed to be aligned back with a direction of the optical axis 22. However, in this method, an angle of a projected electron is changed. In addition, electrons reflected from the target surface 50S has various energy values (see FIG. 5). When the electrons having the various energy values pass through the electric field EF, since deflected angles of the electrons are different due to the energy values thereof, deflection of an energy value of an electron incident on the detector 20 may occur. Thus, precision of an energy loss spectrum is greatly decreased.

On the other hand, in the reflective electron detection apparatus 1 of FIG. 6, the first electric field EF1 may be corrected by the first planar electrode 41, and the second electric field EF2 may be corrected by the second planar electrode 42. In the first planar electrode 41, since a main surface thereof is provided to be perpendicular to the optical axis 11, the first electric field EF1 between the irradiator 10 and the first planar electrode 41 may be formed in parallel with the optical axis 11. In the second planar electrode 42, since a main surface thereof is provided to be perpendicular to the optical axis 21, the second electric field EF2 between the detector 20 and the second planar electrode 42 may be formed in parallel with the optical axis 21.

The reflective electron detection apparatus 1 in which the first electric field EF1 and the second electric field EF2 are corrected may operate as described below. For example, the voltage application part 30 may apply a positive voltage of +3 kV to each of the first planar electrode 41, the second planar electrode 42, and the sample 50. When the irradiator 10 emits, for example, an electron having energy of 1 keV, the electron which passes through the first electric field EF1 may accelerate toward the target surface 50S. The electron emitted from the irradiator 10 may reach energy of approximately 4 keV near the first planar electrode 41. At this point, since the first electric field EF1 is corrected to a direction parallel to the optical axis 11 of the irradiator 10, the electron may not substantially affected by the deflection effect and passes through a trajectory along the optical axis 11. Since a strong electric field is not formed between the first planar electrode 41 and the sample 50 which have an equal electric potential, the electron may reach the target surface 50S through the first passage 41P while maintaining energy of approximately 4 keV. Also, an electron lens of the irradiator 10 may be adjusted depending on a magnitude of a positive voltage applied to the first planar electrode 41, the second planar electrode 42, and the sample 50. Accordingly, the target surface 50S may be irradiated with the electron in consideration of a light concentration effect due to the first electric field EF1.

When the electron reaches the target surface 50S of the sample 50, the electron may be emitted from the target surface 50S through various physical processes near the target surface 50S. The electron emitted from the target surface 50S is, for example, a secondary electron, a back scattering electron, and the like (see FIG. 5) and has various energy values. The back scattering electron includes a zero loss scattering electron. Since a strong electric field is not formed between the second planar electrode 42 and the sample 50 which have an equal electric potential, for example, a portion of electrons emitted from the target surface 50S may pass through the second passage 42P while maintaining an energy value thereof. When passing through the second electric field EF2, the electron which passes through the second passage 42P may decelerate to have an energy of approximately 1 keV and reach the detector 20. At this point, since the second electric field EF2 is corrected in a direction parallel to the optical axis 21 of the detector 20, the electron passes through a trajectory along the optical axis 21 without being substantially affected by the deflection effect. For example, an electron having energy less than or equal to 3 keV may not pass through the second electric field EF2. That is, the second electric field EF2 may have a filter function for removing an electron having an energy value less than or equal to a predetermined energy value.

As such, in the reflective electron detection apparatus 1, while energy of the electron emitted from the irradiator 10 is increased from 1 keV to approximately 4 keV, and while the electron is allowed to reach the target surface 50S of the sample, energy of the electron reflected from the target surface 50S may be decreased to approximately 1 keV, and the electron may be incident on the detector 20. Here, a trajectory of the electron may be maintained to be along the optical axis 11 of the irradiator 10 and the optical axis 21 of the detector 20 by using the first planar electrode 41 and the second planar electrode 42. Thus, an energy loss spectrum may be acquired with higher precision.

### (Configuration of Reflective Electron Detection Apparatus 2)

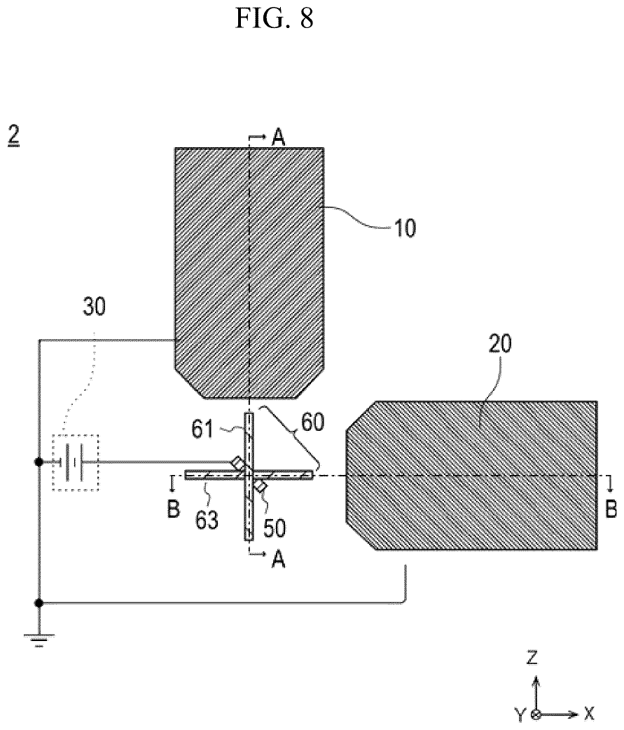

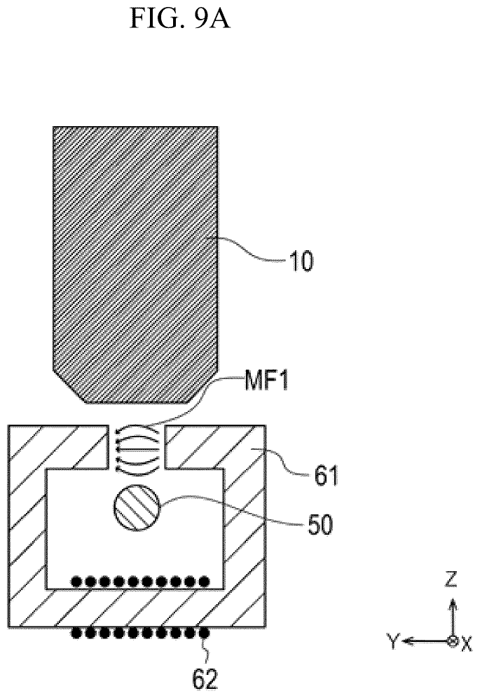

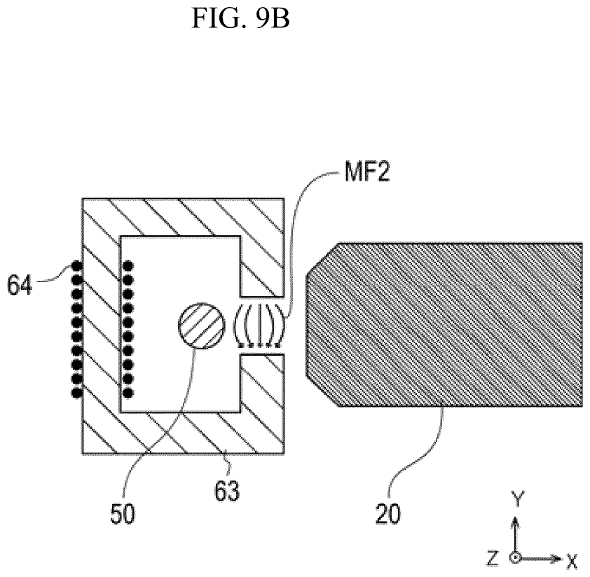

FIGS. 8, 9A, and 9B illustrate an example of a configuration of a reflective electron detection apparatus 2 according to one or more example embodiments of the present disclosure. FIG. 8 illustrates an example of a schematic configuration of the reflective electron detection apparatus 2. FIG. 9A illustrates a cross-sectional configuration taken along line A-A illustrated in FIG. 8. FIG. 9B illustrates a cross-sectional configuration taken along line B-B illustrated in FIG. 8. In order to avoid redundant descriptions, a detailed description of a configuration identical to that of the reflective electron detection apparatus 1 of the above-described embodiment(s) will be omitted.

The reflective electron detection apparatus 2 may include a correction unit 60 instead of the correction unit 40 (of FIG. 1). In the reflective electron detection apparatus 2, a magnetic field may be generated by the correction unit 60. A first electric field between the target surface and the irradiator 10 and a second electric field between the target surface and the irradiator 10 may be corrected by the magnetic field. Except for this, the reflective electron detection apparatus 2 may have a configuration identical or similar to that of the reflective electron detection apparatus 1 described in the above-described embodiment(s).

The correction unit 60 may include, for example, a first yoke 61, a first coil 62, a second yoke 63, and a second coil 64. For example, the first coil 62 may be disposed near the first yoke 61, and the second coil 64 may be disposed near the second yoke 63.

When an electric current flows in the first coil 62, a first magnetic field MF1 may be formed. A direction of the first magnetic field MF1 may be, for example, toward one side in a Y direction. A magnitude of the electric current flowing in the first coil 62 may be adjusted depending on energy of an electron projected from the irradiator 10. The first magnetic field MF1 may affect the electron which passes through the first electric field.

When an electric current flows in the second coil 64, a second magnetic field MF2 may be formed. A direction of the second magnetic field MF2 may be, for example, the same as a direction of the first magnetic field MF1. A magnitude of the electric current flowing in the second coil 64 may be adjusted depending on energy of an electron detected in the detector 20. The second magnetic field MF2 may affect the electron which passes through the second electric field.

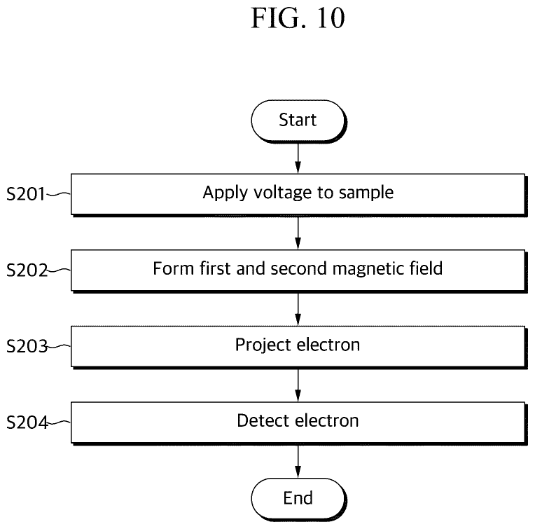

FIG. 10 is a flow chart illustrating an example of a method of detecting an electron using the reflective electron detection apparatus 2. In operation S201, initially, the reflective electron detection apparatus 2 may apply a positive voltage of a predetermined magnitude to the sample 50. Then, in operation S202, the first magnetic field MF1 and the second magnetic field MF2 may be formed in the reflective electron detection apparatus 2. Based on the first magnetic field MF1 and the second magnetic field MF2, a first electric field between the target surface 50S and the irradiator 10 and a second electric field between the target surface 50S and the detector 20 may be corrected.

The first magnetic field MF1 and the second magnetic field MF2 may be formed by, for example, allowing an electric current to flow in the first coil 62 and the second coil 64. An order of operations S201 and S202 may be reversed, or operations S201 and S202 may be simultaneously processed.

In operation S203, after the first magnetic field MF1 and the second magnetic field MF2 are formed, the reflective electron detection apparatus 2 may irradiate the target surface 50S of the sample 50 with an electron from the irradiator 10. Since the electron projected from the irradiator 10 passes through the corrected first electric field, the electron may proceed along the optical axis 10A and reach the target surface 50S.

At least one of electrons which reach the target surface 50S may be reflected from the target surface 50S or a vicinity of the target surface 50S. Since the reflected electron passes through the corrected second electric field, the reflected electron may proceed along the optical axis 20A and may be detected by the detector 20. In the detector 20, energy analysis of the detected electron may be performed.

Similarly to the above-described reflective electron detection apparatus 1, in the reflective electron detection apparatus 2, since a voltage is applied to the sample 50, the first electric field and the second electric field may be formed near the sample 50. The first electric field may accelerate the electron which proceeds from the irradiator 10 to the target surface 50S. The second electric field may decelerate the electron which proceeds from the target surface 50S to the detector 20. In this manner, while the target surface 50S is irradiated with a high-energy electron, energy of an electron moving into the detector 20 may be decreased.

In addition, the first electric field and the second electric field may be corrected by the correction unit 60. Specifically, the first magnetic field MF1 may offset a component of a force, of the electron which passes through the first electric field, applied in a direction approximately perpendicular to the optical axis 10A, and the second magnetic field MF2 may offset a component of a force, of the electron which passes through the second electric field, applied in a direction approximately perpendicular to the optical axis 20A. Thus, a trajectory of the electron which passes through the first electric field and the second electric field may be appropriately maintained. Thus, an energy loss spectrum may be acquired with higher precision. Here, directions approximately perpendicular to the optical axes 10A and 20A may mean directions within a range, within which effects of the first magnetic field MF1 and the second magnetic field MF2 apply. Specifically, the direction approximately perpendicular to the optical axis 10A may be, for example, within a range from eighty degrees to one hundred degrees relative to the optical axis 10A, within a range from eighty-five degrees to ninety-five degrees relative to the optical axis 10A, or at an angle of ninety degrees from the optical axis 10A. In addition, the direction approximately perpendicular to the optical axis 20A may be, for example, within a range from eighty degrees to one hundred degrees relative to the optical axis 20A, within a range from eighty-five degrees to ninety-five degrees relative to the optical axis 20A, or at an angle of ninety degrees from the optical axis 10A. The directions approximately perpendicular to the optical axes 10A and 20A may referred to as directions substantially perpendicular to the optical axes 10A and 20A. Here, the substantially perpendicular directions may be directions crossing at a predetermined angle (e.g., five degrees) inclined from a right angle.

In addition, installing an electrode or the like near the sample 50 may not be required in the reflective electron detection apparatus 2. Thus, a working distance between the sample 50 and each of the irradiator 10 and the detector 20 may be reduced.

The above-described configurations of reflective electron detection apparatuses 1 and 2 are described with reference to main elements included therein and may be variously modified within the scope of the patent claims without being limited to the above-described configuration. Also, an element provided to a general reflective electron detection apparatus may not be excluded.

For example, the reflective electron detection apparatuses 1 and 2 may include a plurality of detectors. For example, a scanning electron microscope (SEM) image of the target surface 50S of the sample 50 may be prepared by at least a portion of the plurality of detectors. Observation for a view for analysis and selection of an appropriate view area may be facilitated by preparing the SEM image.

In addition, at least one of the first planar electrode 41 and the second planar electrode 42 may include a plurality of planar electrode.

In addition, the first planar electrode 41 and the second planar electrode 42 may be separated from each other. Here, each of the first planar electrode 41 and the second planar electrode 42 may be provided as separate members, and a position thereof or the like may be freely adjusted. The first planar electrode 41 and the second planar electrode 42, for example, may be electrically separated from each other.

An example in which the correction unit 40 of the reflective electron detection apparatus 1 includes the first planar electrode 41 and the second planar electrode 42 has been described, but an electrode included in the correction unit 40 may have a shape other than a planar shape, such as a block shape or an angular pillar shape. The correction unit 40 may have electrode having different shapes.

The voltage application part 30 may apply a voltage between the sample 50 and the first planar electrode 41 and between the sample 50 and the second planar electrode 42.

The correction unit may have any configuration for forming the first magnetic field MF1 and the second magnetic field MF2. For example, a member other than a coil and a yoke may be included in the correction unit 60.

Also, in the reflective electron detection apparatuses 1 and 2, an example in which the first electric field and the second electric field are corrected by using an electrode and/or a magnetic field has been described, but the first electric field and the second electric field may be corrected by using an element other than the above-described element(s).

A reflective electron detection apparatus of the present disclosure may include reflective electron detection apparatuses according to the following modified example 1 and modified example 2.

A reflective electron detection apparatus according to the modified example 1 may include an irradiator that irradiates a target surface of a sample with an electron, a detector that detects at least a portion of the electron reflected from the target surface, a correction unit including a first planar electrode provided between the irradiator and the target surface and a second planar electrode provided between the detector and the target surface, and a voltage application part that applies a voltage to the sample, the first planar electrode, and the second planar electrode.

A reflective electron detection apparatus according to the modified example 2 may include an irradiator that irradiates a target surface of a sample with an electron, a detector that detects at least a portion of the electron reflected from the target surface, a correction unit that generates a first magnetic field between the irradiator and the target surface and a second magnetic field between the detector and the target surface, and a voltage application part that applies a voltage to the sample.

The reflective electron detection apparatus may include a communication interface, a memory, and a processor. According to an example embodiment, the above-described reflective electron detection apparatus may be implemented through at least one of a notebook computer, a desktop computer, a laptop computer, and a server computing apparatus.

According to an example embodiment, the communication interface may establish a wired communication channel and/or a wireless communication channel between an external server and at least one element of the reflective electron detection apparatus and may transmit and receive data through the established communication channel. According to an example embodiment, the communication interface may establish a wired communication channel and/or a wireless communication channel between elements of the reflective electron detection apparatus and may transmit and receive data through the established communication channel.

Here, communication, namely, transmission and reception of the data may be performed in a wired manner and/or wirelessly. To this end, the communication interface 110 may include, for example but not limited to, a wired communication module for accessing the Internet or the like through a local area network (LAN), a mobile communication module for transmitting or receiving data by accessing a mobile communication network through a mobile communication base station, a wireless local area network (WLAN)-based communication scheme such as Wireless-Fidelity (Wi-Fi), a near field communication module using a wireless personal area network (WPAN)-based communication scheme such as Bluetooth or Zigbee, a satellite communication module using a global navigation satellite system (GNSS) such as Global Positioning System (GPS), or any combination thereof.

According to an example embodiment, the memory may include a volatile memory and/or a non-volatile memory. According to an example embodiment, the memory may store data used by at least one element (e.g., the processor) of the reflective electron detection apparatus. For example, the data may include software (or an instruction associated therewith). In an example embodiment, when executed by the processor, an instruction may cause the reflective electron detection apparatus to perform operations defined by the instruction.

According to an example embodiment, the processor may be implemented a computer or a device similar thereto depending on hardware, software, or a combination thereof. In terms of the hardware, the processor may be implemented in a form of an electronic circuit that performs a control function by processing an electrical signal. In terms of the software, the processor may be implemented in a form of a program that operates the processor as the hardware. According to an example embodiment, the processor may be operationally connected to an element (e.g., the communication interface and/or the memory) to control the connected element.

According to an example, the processor may include a central processing unit (CPU), application processor (AP), a graphics processing unit (GPU), a neural processing unit (NPU), an image signal processor, a sensor hub processor, and/or a communication processor.

Unless additionally described in the above description, an operation of the reflective electron detection apparatus and/or an element included in the reflective electron detection apparatus may be performed by control by the processor. For example, the processor may execute an instruction associated with an operation of a method for detecting a reflective electron and cause a corresponding element included in the reflective electron detection apparatus to perform the operation.

According to example embodiments, since a voltage is applied to a sample, a first electric field and a second electric field may be formed near a sample. The first electric field may accelerate an electron which proceeds from an irradiator to a target surface, and the second electric field may decelerate the electron which proceeds from the target surface to a detector. Accordingly, energy of the electron with which the target surface is irradiated may be increased, and energy of the electron which moves into the detector may be decreased. In addition, according to example embodiments, the first electric field and the second electric field may be corrected. Thus, a trajectory of the electron which passes through the first electric field and the second electric field may be appropriately maintained. Thus, an energy loss spectrum may be acquired with higher precision.

At least one of the components, elements, modules or units (collectively “components” in this paragraph) described in the specification and/or represented in the drawings, may be embodied as various numbers of hardware, software and/or firmware structures that execute respective functions described above, according to an example embodiment. For example, at least one of these components may use a direct circuit structure or circuitry, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Further, communication between the components may be performed through a bus. Functional aspects of the above example embodiments may be implemented in algorithms that execute on one or more processors. Furthermore, the components or processing steps may employ any number of related art techniques for electronics configuration, signal processing and/or control, data processing and the like.

While the disclosure has been particularly shown and described with reference to example embodiments thereof, it will be understood that various changes in form and details may be made therein without departing from the spirit and scope of the following claims and their equivalents

What is claimed is:

1. A reflective electron detection apparatus comprising:
an irradiator configured to irradiate a target surface of a sample with at least one electron;
a detector configured to detect at least a portion of the at least one electron which is reflected from the target surface;
a voltage application circuitry configured to apply a voltage to the sample; and
a correction circuitry configured to correct a first electric field between the target surface of the sample, to which is the voltage is applied, and the irradiator and a second electric field between the target surface of the sample, to which is the voltage is applied, and the detector.

2. The reflective electron detection apparatus of claim 1, wherein the correction circuitry comprises:
a first planar electrode provided between the irradiator and the target surface; and
a second planar electrode provided between the detector and the target surface.

3. The reflective electron detection apparatus of claim 2, wherein the first planar electrode is configured to correct the first electric field such that the at least one electron which passes through the first electric field proceeds toward the target surface, and
wherein the second planar electrode is configured to correct the second electric field such that the at least a portion of the at least one electron which passes through the second electric field proceeds toward the detector.

4. The reflective electron detection apparatus of claim 2, wherein the at least one electron which is projected from the irradiator reaches the target surface through a first passage provided to the first planar electrode, and
wherein the at least a portion of the at least one electron which is reflected from the target surface reaches the detector through a second passage provided to the second planar electrode.

5. The reflective electron detection apparatus of claim 2, wherein a surface of the first planar electrode faces the irradiator, and
wherein a surface of the second planar electrode faces the detector.

6. The reflective electron detection apparatus of claim 4, wherein the first passage comprises an opening provided to the first planar electrode, and
wherein the second passage comprises an opening provided to the second planar electrode.

7. The reflective electron detection apparatus of claim 4, wherein the first passage comprises a slit provided to the first planar electrode, and
wherein the second passage comprises a slit provided to the second planar electrode.

8. The reflective electron detection apparatus of claim 2, wherein the first planar electrode and the second planar electrode are connected to each other.

9. The reflective electron detection apparatus of claim 2, wherein the first planar electrode and the second planar electrode are separated from each other.

10. The reflective electron detection apparatus of claim 1, wherein the correction circuitry is configured to generate a first magnetic field between the irradiator and the target surface and a second magnetic field between the detector and the target surface.

11. The reflective electron detection apparatus of claim 10, wherein the correction circuitry is configured to offset, by using the first magnetic field, a component of a force, of the at least one electron which passes through the first electric field, applied in a direction substantially perpendicular to an optical axis of the irradiator, and
wherein the correction circuitry is configured to offset, by using the second magnetic field, a component of a force, of the at least a portion of the at least one electron which passes through the second electric field, applied in a direction substantially perpendicular to an optical axis of the detector.

12. The reflective electron detection apparatus of claim 1, wherein the irradiator and the detector are in different directions from the target surface.

13. The reflective electron detection apparatus of claim 1, wherein the detector is configured to analyze an energy of the at least a portion of the at least one electron which is detected.

14. A reflective electron detection apparatus comprising one or more circuitries configured to:
correct a first electric field between a target surface of a sample to, which a voltage is applied, and an irradiator configured to irradiate the target surface with at least one electron; and
correct a second electric field between the target surface of the sample, to which the voltage is applied, and a detector configured to detect at least a portion of the at least one electron which is reflected from the target surface.

15. The reflective electron detection apparatus of claim 14, wherein the one or more circuitries comprise:
a first planar electrode between the irradiator and the target surface and to which the voltage is applied; and
a second planar electrode between the detector and the target surface and to which the voltage is applied.

16. The reflective electron detection apparatus of claim 15, wherein the first planar electrode is configured to correct the first electric field such that the at least one electron which passes through the first electric field proceeds toward the target surface, and
the second planar electrode is configured to correct the second electric field such that the at least a portion of the at least one electron which passes through the second electric field proceeds toward the detector.

17. The reflective electron detection apparatus of claim 14, wherein the one or more circuitries comprise a correction circuitry configured to generate a first magnetic field between the irradiator and the target surface and a second magnetic field between the detector and the target surface.

18. The reflective electron detection apparatus of claim 17, wherein the correction circuitry is configured to offset, by using the first magnetic field, a component of a force, of the at least one electron which passes through the first electric field, applied in a direction substantially perpendicular to an optical axis of the irradiator, and
wherein the correction circuitry is configured to offset, by using the second magnetic field, a component of a force, of the at least a portion of the at least one electron which passes through the second electric field, applied in a direction substantially perpendicular to an optical axis of the detector.

19. The reflective electron detection apparatus of claim 14, wherein the irradiator and the detector are in different directions from the target surface.

20. A reflective electron detection apparatus comprising:
a memory in which at least one instruction is stored; and
at least one processor configured to by executing the at least one instruction:
control to correct a first electric field between a target surface of a sample, to which a voltage is applied, and an irradiator, such that the target surface is irradiated with at least one electron passing through the corrected first electric field from the irradiator;
control to correct a second electric field between the target surface of the sample to which the voltage is applied and a detector; and
detect, by using the detector, at least a portion of the at least one electron reflected from the target surface and passing through the corrected second electric field.
